(19) United States
(12) Patent Application Publication
(10) Pub. No.: US 2023/0210710 A1
(43) Pub. Date: Jul. 6, 2023

(54) FLUID OUTPUTTING MASSAGER

(71) Applicant: SHENZHEN KIMAIRAY TECHNOLOGY CO., LTD, SHENZHEN (CN)

(72) Inventors: ZHEN GONG, SHENZHEN (CN); HAO WANG, SHENZHEN (CN); XIAOLIN TAN, SHENZHEN (CN); CHUANWEI TIAN, SHENZHEN (CN)

(21) Appl. No.: 18/120,428

(22) Filed: Mar. 13, 2023

Related U.S. Application Data
(63) Continuation of application No. PCT/CN2021/082775, filed on Mar. 24, 2021.

(30) Foreign Application Priority Data
Dec. 18, 2020 (CN) 202011511731.4

(51) Int. Cl. A61H 9/00; B65D 47/42

(52) U.S. Cl. CPC A61H 9/0028; B65D 47/42; A61H 2201/1695; A61H 2201/0153

(57) ABSTRACT

A fluid outputting massager includes a fluid storage assembly and a tooth plate connected to the liquid storage assembly to define at least one liquid storage cavity. The tooth plate is arranged with a plurality of fluid outputting teeth, which are soft. A tip portion of each fluid outputting tooth has at least one fluid outputting hole communicating with the fluid storage cavity. The fluid outputting tooth can output fluid from the fluid outputting hole when being pressed.

### CROSS REFERENCE TO RELATED APPLICATIONS

The present application is a continuation-application of International (PCT) Patent Application No. PCT/CN2021/082775, filed on Mar. 24, 2021, which claims the priority of the Chinese patent application No. 202011511731.4, filed on December 18, 2020, and the entire contents of which are hereby incorporated by reference in their entireties.

### TECHNICAL FIELD

The present disclosure relates to the field of health care devices, and in particular to a fluid outputting massager.

### BACKGROUND

As quality of people's lives improves, an increasing number of people pay attention to personal health care. For example, head massage may have an important role in promoting blood circulation in the head. While bathing, people may use massaging brushes to massage the scalp or the body. However, most of the massage brushes in the art may have the massaging function only, i.e., only one function is available. A few massage brushes, which can output fluid, are usually made of metal or may be configured a pump to allow a fluid-outputting tooth to output the fluid.

The massage brushes made of the metal are generally configured with an elastic rolling ball to output the fluid. A structure of the massage brushes may be complex and requires teeth, a spring and the rolling ball to perfectly cooperate with each other to allow the fluid to be output when the massage brushes are massaging the skin and to prevent the fluid from dripping when the massage brushes is not massaging the skin. Therefore, processing of the teeth must be highly precise, and therefore, costs of this type of teeth may be high. Moreover, taking the rolling ball to output the fluid may pinch the user's hair when the brushes are massaging the scalp, and hardness of the metal may be high, generating a poor user experience. Another type of the massage brushes, which are configured with the pump to allow the fluid teeth to output the fluid, may be configured with an electronic member. Therefore, a body of the brushes may be made waterproof. A structure of this type of the massage brushes may be complex and costly.

### SUMMARY OF THE DISCLOSURE

To solve the above technical problem, the present disclosure provides a fluid outputting massager. While the massager is performing massaging, a fluid outputting tooth may be deformed by a pressure to output the fluid. Further, the fluid outputting tooth configured on the fluid outputting massager may be soft. Therefore, while the massager is performing massaging, the scalp or the body skin may be protected.

To solve the above technical problem, the present disclosure provides the following technical solutions.

A fluid outputting massager includes: a fluid storage assembly and a tooth plate connected to the fluid storage assembly. The fluid storage assembly and the tooth plate cooperatively define at least one fluid storage cavity. The tooth plate is arranged with a plurality of fluid outputting teeth, each of the plurality of fluid outputting teeth is a soft tooth. A tip portion of each of the plurality of fluid outputting teeth has at least one fluid outputting hole communicating with the at least one fluid storage cavity. Each of the plurality of fluid outputting teeth, when being pressed, is configured to output a fluid through each of the plurality of fluid outputting teeth.

In the above fluid outputting massager, for each of the plurality of fluid outputting teeth, a thickness of a wall of the fluid outputting tooth from a root portion to the tip portion of the fluid outputting tooth is gradually decreased.

In the above fluid outputting massager, for each of the plurality of fluid outputting teeth, the fluid outputting tooth has a fluid guide hole, the at least one fluid outputting hole is communicated with the fluid guide hole and the at least one fluid storage cavity.

In the above fluid outputting massager, the fluid storage assembly comprises a housing, the tooth plate is capped with the housing to cooperatively define the at least one fluid storage cavity, the housing defines a filling port, a sealing cap is arranged at the filling port.

In the above fluid outputting massager, when the at least one fluid storage cavity refers to a plurality of fluid storage cavies, two adjacent fluid storage cavities of the plurality of fluid storage cavies may be spaced apart from each other a dividing plate.

In the above fluid outputting massager, the fluid storage assembly is arranged with at least one control key, the at least one control key is connected to the dividing plate and is configured to control a corresponding one of the plurality of fluid storage cavities to be communicated with the at least one fluid outputting hole.

In the above fluid outputting massager, the fluid storage assembly further comprises an upper cover, wherein the upper cover is disposed at an outside of the housing.

In the above fluid outputting massager, the number of the at least one fluid outputting hole is 1-8.

In the above fluid outputting massager, the fluid storage assembly is arranged with a reset member configured to reset the tooth plate.

In the above fluid outputting massager, the fluid storage assembly further comprises a one-way valve arranged on the housing.

The above fluid outputting massager further includes a holding pendant. The holding pendant is disposed at an end of the housing or at an end of the upper cover.

In the above fluid outputting massager, the other end of the housing defines a drainage hole.

In the above fluid outputting massager, the upper cover has a first adsorption member, the housing has a second adsorption member, the second adsorption member is adsorbed to and attached to the first adsorption member.

The above fluid outputting massager is a fluid outputting massaging comb, beauty massage brushes, or body massage brushes.

In the above fluid outputting massager, the plurality of fluid storage cavities are arranged in a horizontal direction or in a vertical direction.

The above fluid outputting massager further includes a lower cover. The lower cover is snapped with the housing, and the lower cover is spaced at a pre-determined distance from the plurality of fluid outputting teeth.

According to the present disclosure, a fluid outputting massager is provided. The fluid outputting massager may be slightly pressed to allow the head of the fluid outputting tooth (i.e., the tip portion) to contact with the skin. While fluid outputting tooth is massaging the skin, the fluid outputting tooth may be deformed by an external force, such that a pressure inside the fluid outputting tooth is less than the atmospheric pressure, and therefore, the fluid is output. In this way, while the treatment fluid is being output, massaging may be performed. Further, the tooth may be soft and, while performing massaging, may not hurt the skin, may not pinch the hair, and may not scratch the skin. In addition, the fluid outputting massager of the present disclosure may output the fluid smoothly, the user may be comfortable, the fluid outputting massager may have a simple structure, a low processing requirement may need to be met, and production costs may be reduced effectively.

### BRIEF DESCRIPTION OF THE DRAWINGS

FIG. 1 is a structural schematic view of the entire fluid outputting massager according to an embodiment of the present disclosure.

FIG. 2 is a cross sectional view of the fluid outputting massager according to an embodiment of the present disclosure.

FIG. 3 is an explosive view of the fluid outputting massager according to an embodiment of the present disclosure.

FIG. 4 is a cross sectional view of a tooth plate of the fluid outputting massager according to an embodiment of the present disclosure.

FIG. 5 is a structural schematic view of an upper cover and a lower cover separated from the upper cover of the fluid outputting massager according to an embodiment of the present disclosure.

FIG. 6 is a structural schematic view of an inner wall of the tooth plate of the fluid outputting massager according to an embodiment of the present disclosure.

### DETAILED DESCRIPTION

In order to clearly illustrate objectives, technical solutions and advantages of the present disclosure, technical solutions will be described in further detail below by referring to the accompanying drawings and embodiments. It shall be understood that specific embodiments described herein are intended only to explain the present disclosure, but do not limit the present disclosure.

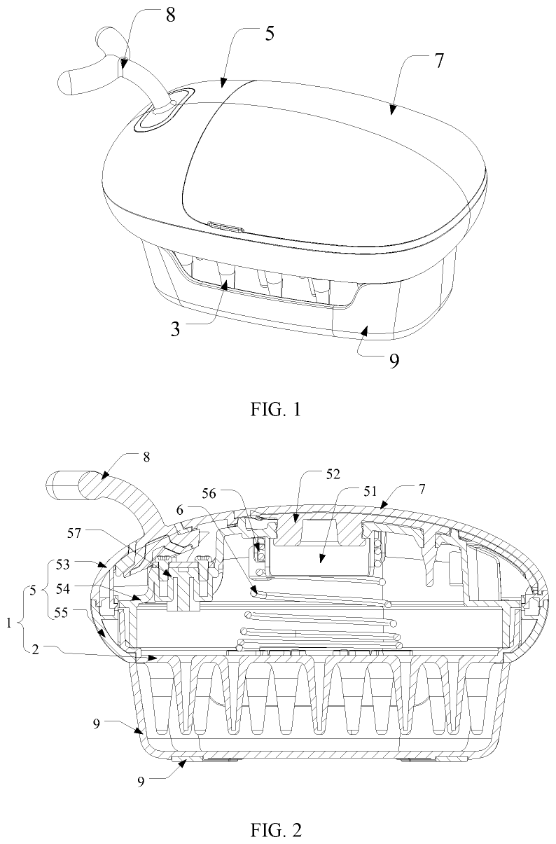

As shown in FIGS. 1, 2, 3 and 4, the present disclosure provides a fluid outputting massager, including a fluid storage assembly 1 and a tooth plate 2. The tooth plate 2 is connected to the fluid storage assembly 1 to cooperatively define at least one fluid storage cavity (not shown in the drawings). The tooth plate 2 is arranged with a plurality of fluid outputting teeth 3. The fluid outputting teeth 3 may be soft teeth. A tip portion of each of the plurality of fluid outputting teeth 3 has at least one fluid outputting hole 31 communicating with the fluid storage cavity. When the fluid outputting teeth 3 are pressurized, the fluid may be output from the fluid outputting hole 31. When the massager contacts the skin and moves back and forth reciprocatively on the skin, the fluid outputting teeth 3 may be deformed by pressure to release a treatment fluid in the fluid storage cavity, such that the user may apply the treatment fluid while performing massaging. The fluid outputting massager may be used easily.

While the fluid outputting massager is being in use, the fluid storage cavity may receive essential oil, shampoo, hair mask, shower gel and other flowing fluids for cleaning or for skin care. While performing massaging, a head of each fluid outputting tooth 3 (i.e., the tip portion) contacts the skin. The fluid outputting tooth 3 is deformed by an external force generated when the massager is being moved, such that a pressure inside the fluid outputting tooth 3 is less than the atmospheric pressure, and the fluid is output. In this way, while the treatment fluid is being output, massaging is performed. While the soft tooth is contacting and massaging the skin, no pain is caused, hair may not be pinched, and the skin may not be scratched. Compared to the fluid outputting massager in the art that is made of metal having a large hardness or is configured with a pump to take a pressure to output the fluid, the fluid outputting massager of the present disclosure may output the fluid smoothly, the user may be comfortable, and user needs may be met. Further, the fluid outputting massager has a simple structure, a processing requirement may be low, and production costs may be reduced.

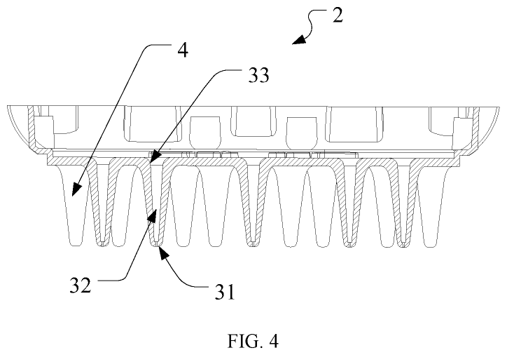

As shown in FIG. 2 and FIG. 4, the fluid outputting tooth 3 may be cone shaped. A thickness of a wall of the fluid outputting tooth 3 from a root portion to the tip portion of the fluid outputting tooth 3 is gradually decreased. The root portion refers to a portion disposed near the tooth plate, and the tip portion/head portion refers to a portion of the tooth away from the tooth plate. Therefore, the root portion of the fluid outputting tooth 3 may be stronger and may be less likely to be deformed. When the fluid outputting massager is in use, the tip portion and a middle portion of the fluid outputting tooth 3 may be deformed by the pressure to allow the fluid outputting hole 31 to release the fluid. The root portion and a portion of the fluid outputting tooth 3 closer to the tooth plate may be slightly deformed or not be deformed, ensuring the treatment fluid to be smoothly flowing to the fluid outputting hole 31, ensuring the treatment fluid to be released continuously. Specifically, the thickness of the wall of the fluid outputting tooth 3 is 0.8 mm-2 mm. Specifically, the wall thickness may be determined to match a diameter of the fluid outputting tooth 3. For example, a thickness of the wall at the root portion of the fluid outputting tooth 3 may be 1 mm. A thickness of the wall at the head portion of the fluid outputting tooth 3 may be 0.8 mm. A thickness of the wall at the middle portion of the fluid outputting tooth 3 may be gradually changed from 1 mm to 0.8 mm in a direction from the root portion to the tip portion.

The fluid outputting tooth 3 has a fluid guide hole 32. The fluid outputting hole 31, the fluid guide hole 32, and the fluid storage cavity are communicated with each other. Specifically, the fluid guide hole 32 is cone shaped, such as cone shaped, elliptical cone shaped, polygonal cone shaped. The fluid may be guided by the cone-shaped fluid guide hole 32, allowing the treatment fluid to quickly flow to the fluid outputting hole 31.

Further, a fluid guide corner or a fluid guide arc 33 is arranged at a fluid inlet end of the fluid guide hole 32 to allow the treatment fluid in the fluid storage cavity to flow into the fluid guide hole 32 more smoothly, and the treatment fluid may not be wasted. Of course, the fluid guide hole 32 may be columnar, such as cylindrical, elliptical, squared-column shaped, and so on, as long as the fluid outputting teeth 3 can be deformed to release the fluid while the massaging is performed.

In the present embodiment, the fluid outputting tooth 3 is a silicone tooth. The silicone may be food-grade or medical-grade silicone to ensure safety of the fluid outputting tooth 3, allowing the user to use the massager assuredly. Further, hardness of the fluid outputting tooth 3 may be 30 degrees-60 degrees, ensuring a deformation extent of the fluid outputting tooth 3 can allow the fluid to be guided smoothly and to be output smoothly.

Specifically, an end face of the head portion of the fluid outputting tooth 3 is curved, such that a contact area between the fluid outputting tooth 3 and the skin is smaller, and a massaging feeling may be improved. Further, the tooth plate 2 is a soft tooth plate. While massaging is being performed, the tooth plate 2 may also be deformed to apply a pressure to the fluid guide hole 32, further facilitating the fluid to be output smoothly.

In some embodiments, a plurality of rigid teeth 4 are arranged on the tooth plate 2. Each rigid tooth 4 is spaced apart from and slightly shorter than the fluid outputting tooth 3. When the fluid outputting massager is used for scalp care, the rigid teeth 4 may massage the scalp and pluck the hair, such that the fluid may flow to reach the scalp, allowing the treatment fluid to apply to the scalp to achieve a better care effect. When the fluid outputting massager is used for skin care, the rigid teeth 4 and fluid outputting teeth 3 may achieve a better massaging effect while applying the treatment fluid. Further, the rigid teeth 4 may prevent the fluid outputting teeth 3 from being excessively deformed, ensuring the fluid to be output smoothly.

In an embodiment, the number of fluid outputting holes 31 is 1-8. The fluid outputting holes are evenly distributed radially along the tip portion of the fluid outputting tooth 3. In this way, the pressure inside the fluid guide hole 32 may be balanced with the external air pressure, allowing the treatment fluid to be output smoothly. In some embodiments, the number of fluid outputting holes 31 is 3-5. Further, the curved end face allows the plurality of fluid outputting holes 31 to be distributed on different planes, ensuring that, while massaging is being performed, some of the fluid outputting holes 31 are communicated with the outside to balance the air pressure inside the fluid outputting hole with the outside air pressure, such that the fluid may be output smoothly.

Further, the fluid outputting hole 31 may be a cross-shaped hole, a round hole, an elliptical hole or a conical hole. A size of the fluid outputting hole 31 may be 0.1 mm-0.25 mm. A shape and a size of the fluid outputting hole 31 may be determined based on viscosity of the treatment fluid. In this way, the fluid may be output smoothly when the fluid outputting massager is being pressed; and the fluid may not leak when the fluid outputting massager is not pressed. The present disclosure does not limit the shape and the size of the fluid outputting hole 31.

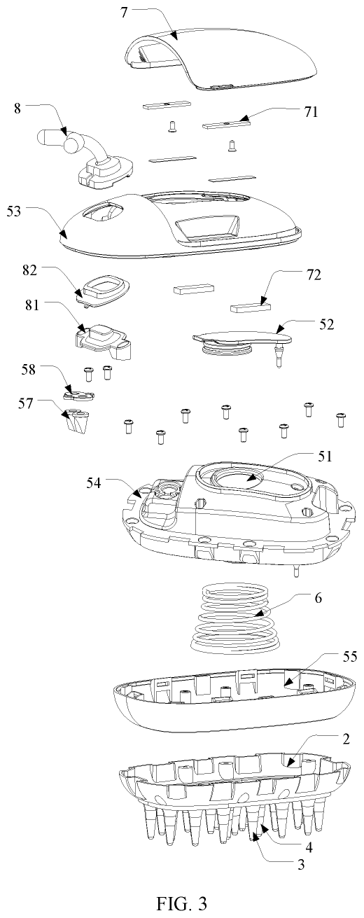

As shown in FIG. 2 and FIG. 3, the fluid storage assembly 1 includes a housing 5. The tooth plate 2 is capped with the housing 5 to cooperatively define the fluid storage cavity. The housing 5 defines a filling port 51. A sealing cap 52 is arranged at the filling port 51. A desired treatment fluid may be input to the cavity through the filling port 51.

In some embodiments, a plurality of fluid storage cavies are defined. Two adjacent fluid storage cavities may be spaced apart from each other by configuring a dividing plate (not shown in the drawings). The fluid storage assembly 1 is arranged with at least one control key (not shown in the drawings). The control key is connected to the dividing plate and may control the dividing plate to move to control a corresponding one of the plurality of fluid storage cavities to be communicated with the fluid outputting hole 31. By configuring the dividing plate, the fluid storage assembly 1 has the plurality of fluid storage cavities, such that the user may input the treatment fluid as required. For example, the required amount of treatment fluid to be used for a plurality of times may be input into one fluid storage cavity at once and may be stored separately in each of the plurality of fluid storage cavities. A plurality of dosages may be carried, and an additional storage bottle may not need to be carried. The fluid outputting massager may be used easily by people who travel or are on business.

Specifically, the plurality of fluid storage cavities are arranged in a horizontal direction or arranged into a plurality of layers long a vertical direction. When the dividing plate is arranged in the vertical direction, the fluid storage cavities are distributed from left to right. In some embodiments, the dividing plate is arranged in the horizontal direction, and the fluid storage cavities are distributed into layers from upper to lower. The present disclosure does not limit the arrangement of the cavities and the dividing plate, as long as the plurality of fluid storage cavities are defined and to be able to be communicated with the fluid outputting hole 31.

In an embodiment, the fluid storage assembly 1 further includes a one-way valve 57 arranged on the housing 5. The one-way valve 57 is connected to the housing 5 through a valve pressure plate 58. When the fluid outputting tooth 3 is pressed to be deformed to output the fluid, air is introduced into the fluid storage cavity through the one-way valve 57, such that the air pressure in the fluid storage cavity is balanced with the external air pressure. In this way, when the fluid outputting tooth 3 is pressed, the fluid outputting tooth 3 may continuously output the fluid, and the fluid may be output smoothly.

Arranging the one-way valve 57 and defining the plurality of fluid outputting holes 31 on different planes of the end face of the fluid outputting tooth 3 may achieve a same effect. By arranging the one-way valve 57, the air pressure in the fluid outputting hole 32 may be balanced with the external air pressure. In some embodiments, either the one-way valve 57 is arranged, or the plurality of fluid outputting holes 31 are defined on different planes of the end face of the fluid outputting tooth 3. In some embodiments, the one-way valve 57 is arranged, and at the same time, the plurality of fluid outputting holes 31 are defined on different planes of the end face of the fluid outputting tooth 3. Therefore, dual guarantee is achieved, ensuring the fluid outputting tooth 3 to output the fluid smoothly.

In some embodiments, the fluid storage assembly 1 is arranged with a reset member 6 to reset the tooth plate 2. When the fluid outputting tooth 3 is deformed by pressure, the tooth plate 2 may also be deformed. The reset member 6 may reset the tooth plate 2, such that the air pressure in the fluid storage cavity is balanced with the external air pressure. In this way, it is further ensured that the fluid outputting tooth 3 can output the fluid continuously. Specifically, the reset member 6 is a reset spring. One or more reset members 6 may be arranged based on needs. A structure of the fluid storage assembly 1 may be simple and reliable.

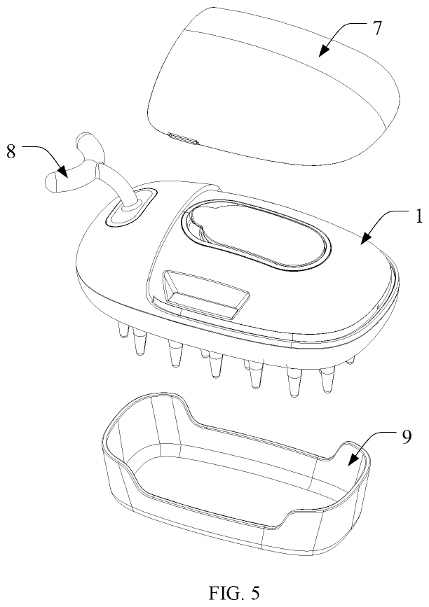

As shown in FIG. 5, the fluid reservoir assembly 1 further includes an upper cover 7. The upper cover 7 is disposed at an outside of the housing 5. The upper cover 7 is closed over the filling port 51 to conceal the filling port 51, allowing the fluid outputting massager to have a better appearance. The upper cover 7 has a first adsorption member 71. The housing 5 has a second adsorption member 72 which is attracted to the first adsorption member 71 by adsorption. In this way, the upper cover 7 may be dissembled or assembled easily, allowing the fluid to be filled more easily.

Specifically, the housing 5 includes an upper housing 53, a middle housing 54 and a lower housing 55. The middle housing 54 is snapped to the tooth plate 2 to cooperatively define the fluid storage cavity. The lower housing 55 sleeves an outer edge of the tooth plate 2 and is snapped to the upper housing 53 to allow the tooth plate 2 to be connected to the middle housing 54 more tightly, preventing the fluid from leaking.

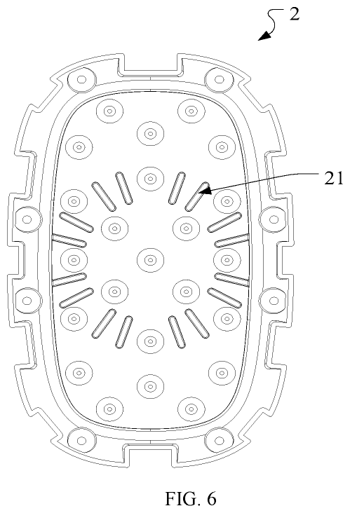

As shown in FIG. 6, an inner top of the middle housing 54 has a slot 56 for mounting the reset member 6. An end of the reset member 6 is received in the slot 56, and the other end of the reset member 6 abuts against the inner bottom wall of the tooth plate 2. Further, the inner bottom wall of the tooth plate 2 is arranged with a protrusion 21 (as shown in FIG. 6). In this way, the reset member 6 may be prevented from completely contacting the tooth plate 2 and blocking the treatment fluid from flowing, such that the plurality of fluid outputting teeth 3 may output the fluid uniformly.

The fluid outputting massager further includes a holding pendant 8. The holding pendant 8 is disposed at an end of the housing 5 or an end of the upper cover 7. The holding pendant 8 is connected to the housing 5 or the upper cover 7 by a pendant press 81, such that the holding pendant 8 has a certain weight-bearing capacity. While the massager is in use, the holding pendant 8 may be configured to assist holding of the fluid outputting massager.

Further, a decorative ring 82 is arranged at the holding pendant 8, allowing the fluid outputting massager to have a better appearance. Specifically, when the one-way valve 57 is arranged in the fluid storage assembly 1, the holding pendant 8 may be arranged on the upper housing 53 and disposed at the one-way valve 57. Further, an air hole is defined to allow air to enter the fluid storage cavity smoothly and to provide a better appearance. The holding pendant 8 may be Y-shaped, ring-shaped or hook-shaped. The present disclosure does not limit a shape of the holding pendant 8. A connection portion of the holding pendant 8 may be curved and extends in a direction same as a direction that a finger grips the housing. While the massager is in use, a middle finger and an index finger of the user may hold the holding pendant 8, such that when massaging is being performed, the fluid may not be sticked to the hand palm, and the massager may not be slipped out and may not fall to the ground.

In some embodiments, the other end of the housing 5 defines a drainage hole (not shown in the drawing). When the fluid storage cavity is cleaned, the fluid outputting massager may be suspended by the holding pendant 8, such that water in the fluid storage cavity may be output through the drainage hole, ensuring an inside of the fluid storage cavity to be dry. In this way, when the treatment fluid is added next time, the treatment fluid may not be contaminated. Of course, a sealing plug (not shown in the drawings) may be arranged at the drainage hole. Therefore, while the massager is being in use, the treatment fluid in the fluid storage cavity may be prevented from leaking through the drainage hole.

The fluid outputting massager may be a fluid outputting massaging comb, beauty massage brushes, or body massage brushes. A density of the fluid outputting teeth 3 and a size of the fluid outputting hole 31 may be determined based on needs, such that the massager may be applicable for different treatment fluids and for different parts of the body.

As shown in FIGS. 1, 2 and 5, the fluid outputting massager further includes a lower cover 9. The lower cover 9 is snapped with the housing 5. The lower cover 9 is spaced at a pre-determined distance from the fluid outputting teeth 3, such that the tip portion of each fluid outputting tooth 3 does not touch the lower cover 9, and the fluid outputting teeth 3 may be protected. In this way, the fluid outputting teeth 3 may not be pressurized to output the fluid, while the massager is being stored or carried. Further, the fluid outputting teeth 3 may be protected against dust. A bottom of the lower cover 9 is further arranged with an anti-slipping pad 91, preventing the fluid outputting massager from being slipped off while being stored or used.

In summary, the present disclosure provides a fluid outputting massager. When the fluid outputting massager may be slightly pressed, the fluid outputting teeth may be deformed by the pressure to guide and output the treatment fluid in the fluid storage cavity, such that the user may apply the treatment fluid while performing the massaging, the fluid outputting massager may be used easily. While the massager is in use, the head portion (i.e., tip portion) of each fluid outputting tooth contacts the skin. The tooth may be deformed by the external force while performing the massaging, such that the pressure inside the tooth is less than the atmospheric pressure, and therefore, the fluid is output. While the treatment fluid is output, the massaging may be achieved. Further, when the soft tooth contacts and massages the skin, no pain is caused, the hair may not be pinched, and the skin may not be scratched. Compared to the fluid outputting massager in the art that is made of metal having a large hardness or is configured with a pump to take a pressure to output the fluid, the fluid outputting massager of the present disclosure may output the fluid smoothly, the user may be comfortable, and user needs may be met. Further, the fluid outputting massager has a simple structure, a processing requirement may be low, and production costs may be reduced.

Further, a plurality of fluid storage cavities may be defined. Two adjacent fluid storage cavities may be spaced apart by the dividing plate. The fluid storage assembly is arranged with at least one control key. The control key is connected to the dividing plate to control the corresponding one fluid storage cavity to be communicated with the fluid outputting hole. The plurality of fluid storage cavities may receive a plurality of dosages of fluid that can be used for a plurality of times. In this way, an additional fluid storage bottle may not need to be carried. The fluid outputting massager may be used easily by people who travel or are on business.

It shall be understood that, any ordinary skilled person in the art may perform equivalent substitutions or alterations based on the technical solutions and concepts of the present disclosure. All substitutions and alterations shall fall within the scope of the appended claims of the present disclosure.

What is claimed is:

1. A fluid outputting massager, comprising: a fluid storage assembly and a tooth plate connected to the fluid storage assembly,
wherein the fluid storage assembly and the tooth plate cooperatively define at least one fluid storage cavity;
the tooth plate is arranged with a plurality of fluid outputting teeth, each of the plurality of fluid outputting teeth is a soft tooth;
a tip portion of each of the plurality of fluid outputting teeth has at least one fluid outputting hole communicating with the at least one fluid storage cavity;
each of the plurality of fluid outputting teeth, when being pressed, is configured to output a fluid through each of the plurality of fluid outputting teeth.

2. The fluid outputting massager according to claim 1, wherein, for each of the plurality of fluid outputting teeth, a thickness of a wall of the fluid outputting tooth from a root portion to the tip portion of the fluid outputting tooth is gradually decreased.

3. The fluid outputting massager according to claim 1, wherein, for each of the plurality of fluid outputting teeth, the fluid outputting tooth has a fluid guide hole, the at least one fluid outputting hole is communicated with the fluid guide hole and the at least one fluid storage cavity.

4. The fluid outputting massager according to claim 1, wherein, the fluid storage assembly comprises a housing, the tooth plate is capped with the housing to cooperatively define the at least one fluid storage cavity, the housing defines a filling port, a sealing cap is arranged at the filling port.

5. The fluid outputting massager according to claim 4, wherein, when the at least one fluid storage cavity refers to a plurality of fluid storage cavies, two adjacent fluid storage cavities of the plurality of fluid storage cavies may be spaced apart from each other a dividing plate.

6. The fluid outputting massager according to claim 5, wherein, the fluid storage assembly is arranged with at least one control key, the at least one control key is connected to the dividing plate and is configured to control a corresponding one of the plurality of fluid storage cavities to be communicated with the at least one fluid outputting hole.

7. The fluid outputting massager according to claim 1, wherein the fluid storage assembly further comprises an upper cover, wherein the upper cover is disposed at an outside of the housing.

8. The fluid outputting massager according to claim 1, wherein the number of the at least one fluid outputting hole is 1-8.

9. The fluid outputting massager according to claim 1, wherein the fluid storage assembly is arranged with a reset member configured to reset the tooth plate.

10. The fluid outputting massager according to claim 4, wherein the fluid storage assembly further comprises a one-way valve arranged on the housing.

11. The fluid outputting massager according to claim 4, further comprising a holding pendant, wherein the holding pendant is disposed at an end of the housing or at an end of the upper cover.

12. The fluid outputting massager according to claim 11, wherein the other end of the housing defines a drainage hole.

13. The fluid outputting massager according to claim 11, wherein the upper cover has a first adsorption member, the housing has a second adsorption member, the second adsorption member is adsorbed to and attached to the first adsorption member.

14. The fluid outputting massager according to claim 1, wherein the fluid outputting massager is a fluid outputting massaging comb, beauty massage brushes, or body massage brushes.

15. The fluid outputting massager according to claim 4, wherein the plurality of fluid storage cavities are arranged in a horizontal direction or in a vertical direction.

16. The fluid outputting massager according to claim 11, further comprising a lower cover, wherein the lower cover is snapped with the housing, and the lower cover is spaced at a pre-determined distance from the plurality of fluid outputting teeth.
